(19) United States
(12) Patent Application Publication
(10) Pub. No.: US 2013/0342561 A1
(43) Pub. Date: Dec. 26, 2013

(54) DATA VISUALIZATION RENDERING SYSTEM AND METHOD

(71) Applicant: Andrew John Cardno, San Diego, CA (US)

(72) Inventor: Andrew John Cardno, San Diego, CA (US)

(73) Assignee: BUSINESS INTELLIGENCE SOLUTIONS SAFE B.V., Amsterdam (NL)

(21) Appl. No.: 13/811,165

(22) PCT Filed: Jul. 18, 2011
(86) PCT No.: PCT/NZ2011/000138

§ 371 Date: Jun. 28, 2013

Related U.S. Application Data
(60) Provisional application No. 61/365,609, filed on Jul. 19, 2010.

(51) Int. Cl. G06T 11/20

(52) U.S. Cl. CPC G06T 11/206
USPC 345/592

(57) ABSTRACT

In a data visualization system, a method of generating a representation of data values for a plurality of data points being visualized in an image space, the method comprising the steps of the data visualization system: i) retrieving data values from a data storage module in communication with the data visualization system, wherein a first data value is associated with a first data point, ii) determining a size and a transparency value for a first icon based on the first data value, iii) rendering the first icon in two dimensions in a position associated with the first data point in the image space, wherein the first icon is rendered based on the determined size and transparency values to generate a representation of the data value.

### FIELD OF THE INVENTION

The present invention relates to a data visualization rendering system and method. In particular, the present invention relates to a method and system for representing data values in two dimensions.

### BACKGROUND

Data visualization systems are used to help entities visualize and understand their data. The data may be, for example, commercial, financial, technical, marketing, gaming or indeed any other type of data captured by entities of any industry. The amount of data being captured by various entities in a number of different industries is continually growing and can exceed data storage capacities in the Terabytes range.

Data visualization systems are required to provide accurate representations of the data in a form that enables the users to easily distinguish features of the data. These visualization systems aim to render data points in a data visualization system in a fast and efficient manner. This is particularly pertinent when rendering vast amounts of data as both time and energy efficient systems are advantageous in the eyes of the majority of entities.

It is known to represent vast amounts of data in a heatmap form to more easily enable users to distinguish or recognize important elements in the visualization.

One current trend in heatmap data visualization techniques is that of rendering data points in data visualizations using distribution algorithms for the data points based on the data value being rendered for the specific data point. These methods effectively render a surface to represent the data values at and around the data points.

However, this method of data point rendering is computer intensive, especially when having to take into account multiple distribution algorithms when data points are positioned close to each other.

Further, this type of data point rendering is also problematic when rendering smaller value data points close to larger value data points as the smaller data points may be swamped by the distribution values of the larger data points causing the smaller data points to become difficult to visibly distinguish. This can result in the user not being shown relevant or pertinent data in the visualization.

It is known to represent data points using basic two dimensional icons. However, according to these known methods, the information being represented can become lost when representing a large number of data points in a small amount of image space. That is, each data point being represented may start to obscure neighboring data points resulting in a loss of information.

Some known methods have attempted to reduce the loss of information by making all the data points transparent. However, this single blanket transparency across all data points only helps to detract from the more pertinent data values especially when rendering many varying sized data points in a small image space. These types of methods also result in a visualization that merely highlights overlapping areas without taking into account the value of the data points which are overlapping. That is, two small data points that overlap will be represented using a transparency value that is the same as two larger overlapping data points.

An object of the present invention is to provide a data point visualization method and system of increased efficiency and speed of operation.

A further object of the present invention is to provide a data point visualization method and system that doesn't obscure smaller data points when positioned close to larger data points.

A further object of the present invention is to provide a data point visualization method and system that provides a clear representation of data values without the need to render a three dimensional surface.

Each object is to be read disjunctively with the object of at least providing the public with a useful choice.

The present invention aims to overcome, or at least alleviate, some or all of the afore-mentioned problems.

### SUMMARY OF THE INVENTION

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

According to one aspect, the present invention provides in a data visualization system, a method of generating a representation of data values for a plurality of data points being visualized in an image space, the method comprising the steps of the data visualization system: i) retrieving data values from a data storage module in communication with the data visualization system, wherein a first data value is associated with a first data point, ii) determining a size and a transparency value for a first icon based on the first data value, iii) rendering the first icon in two dimensions in a position associated with the first data point in the image space, wherein the first icon is rendered based on the determined size and transparency values to generate a representation of the data value.

According to a further aspect, the present invention provides a data visualization system for generating a representation of data values for a plurality of data points being visualized in an image space, the data visualization system comprising: a data retrieval engine arranged to retrieve data values from a data storage module in communication with the data visualization system, wherein a first data value is associated with a first data point, a size and transparency determination engine arranged to determine a size and a transparency value for a first icon based on the first data value, and a rendering engine arranged to render the first icon in two dimensions in a position associated with the first data point in the image space, wherein the first icon is rendered based on the determined size and transparency values to generate a representation of the data value.

### BRIEF DESCRIPTION OF THE DRAWINGS

Embodiments of the present invention will now be described, by way of example only, with reference to the accompanying drawings, in which:

FIG. 1 shows a system block diagram according to an embodiment of the present invention;

FIG. 2 shows a flow diagram of a method used according to an embodiment of the present invention;

FIGS. 3A and 3B show an example of a single icon according to an embodiment of the present invention;

FIG. 4 shows a flow diagram of a method used according to an embodiment of the present invention;

FIGS. 5A and 5B show an example of two overlapping icons according to an embodiment of the present invention;

FIGS. 6A and 6B show a further example of two overlapping icons according to an embodiment of the present invention; and

FIG. 7 shows a gaming environment system block diagram according to an embodiment of the present invention.

### DETAILED DESCRIPTION OF THE INVENTION

### First Embodiment

Embodiments of the present invention are described herein with reference to a system adapted or arranged to perform a data visualization rendering method.

The following described invention is suitable for use in conjunction with other methods, and the incorporation into one or more systems, for example as described in METHODS, APPARATUS AND SYSTEMS FOR DATA VISUALIZATION AND RELATED APPLICATIONS earlier filed by the applicant and published as WO2009/154484, which is hereby incorporated by reference.

In summary, the system includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system is arranged to be in communication with external data storage systems or devices in order to retrieve the relevant data, as described below.

It will be understood that the system herein described includes one or more elements that are arranged to perform the various functions and methods. The following portion of the description is aimed at providing the reader with an example of a conceptual view of how various modules and/or engines that make up the elements of the system may be interconnected to enable the functions to be implemented. Further, the following portion of the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data visualization computer, a database query computer, a graphical analysis computer, a retail environment analysis computer, a gaming data analysis computer, a manufacturing data analysis computer, a business intelligence computer, a social network data analysis computer, a gene sequence analysis computer etc., where the computer has been specifically adapted to perform the described steps on specific data captured from an environment associated with a particular field.

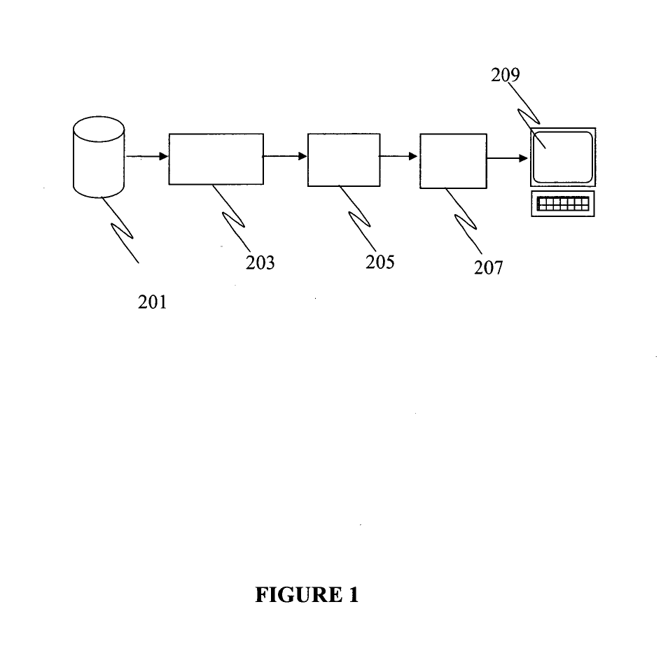

According to this embodiment there is shown in FIG. 1 a data storage module 201 that is arranged to store data. The data storage module may be any suitable type of data storage system. For example, it may be an enterprise data warehouse (EDW), a data mart, a database, a storage array or any other suitable device or groups of devices that can store data for later retrieval. Further, the data storage module may be a cache memory used to temporarily store incoming data captured in real time. For example, the incoming data may be streaming data.

The data provided as an input to the rendering system may be of any suitable type of data, for example, real world data including, but not limited to, gaming or gambling data associated with a gaming environment such as a casino, event data, test or quality control data obtained from a manufacturing environment, business data retrieved from an accounting system, sales data retrieved from a company database, data received or accumulated from a social network, gene sequence data retrieved from a gene sequencing system etc. All this data may be received by the system in real time (e.g. by receiving streaming data) in a cache memory or may be stored in a more permanent manner.

A data retrieval engine 203 is in communication with the data storage module 201 to enable the data stored within the storage module to be retrieved and transferred to the other elements of the rendering system.

A size and transparency determination engine 205 is in communication with the data retrieval engine 203. The size and transparency determination engine receives the retrieved data and analyses it to determine the size and transparency of a two dimensional icon being used to represent a data point having a data value associated with at least a portion of the retrieved data.

A rendering engine 207 is in communication with the size and transparency determination engine 205. The rendering engine is arranged to render the icons at the data points for the data values received and output the rendered icons for display in an image space on an output device 209, which is in communication with the rendering engine 207. The output device in this embodiment is a display module forming part of a data visualization computing system.

As an alternative to, or in conjunction with, the display module, further output modules may be provided to output the results of the rendering engine. The further output module may be a printing device in communication with the described system to receive print control data so that representations of the data may be printed on any suitable print medium. Alternatively, the further output module may be an interface that enables the data output from the rendering engine to be interfaced with other data handling modules or storage devices. As a further alternative, the output module may be the same or different data storage module as described above.

The raw data retrieved by the data retrieval engine is therefore analyzed and converted by the size and transparency determination engine and rendering engine to provide a data visualization in a specific format as described in more detail below. The output data is provided to the display and/or further output modules to enable a user to visualize the raw data in a manner that conveys more useful or hidden information that would otherwise be lost.

Therefore, the data visualization techniques described herein transform the raw data received into a data visualization format that enables further or hidden information within the raw data to be visually represented in a manner that conveys the information to a user in an efficient and useful manner.

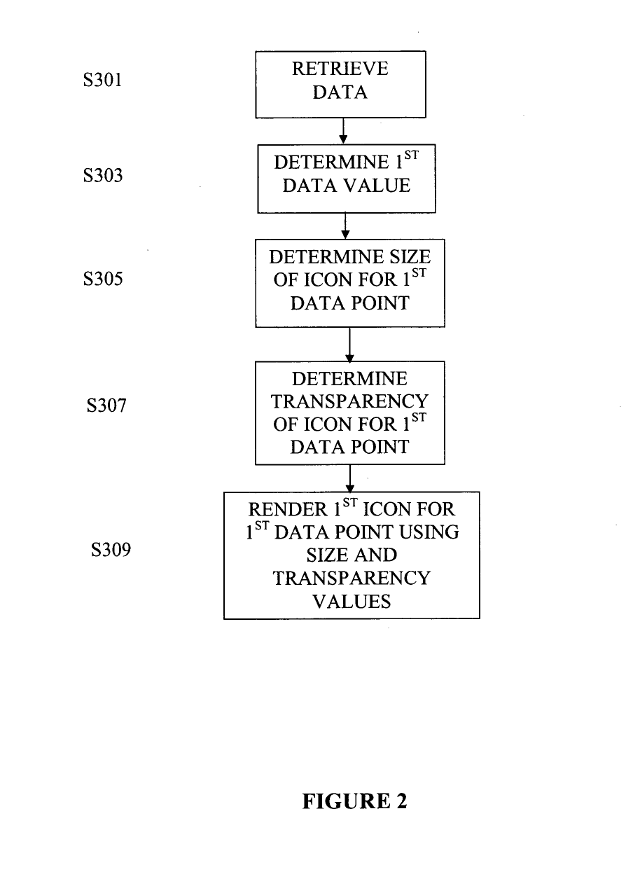

FIG. 2 shows a flow diagram of the general method for generating a representation of data values according to this embodiment. Data values are represented using a plurality of icons at data points which represent the data in image space.

According to step S301, data (including data values) is retrieved from the data storage module. At step S303, a first data value is determined from the data being retrieved. At step S305, the size and transparency determination engine determines an icon size value associated with the first retrieved data value. At step S307, the size and transparency determination engine determines an icon transparency value associated with the first retrieved data value. At step S309, the rendering engine renders the first data value as a first icon at the first data point using the determined size and transparency values associated with the icon.

A simple example now follows showing how the size and transparency determination engine and the rendering engine create a single icon for a single data point within the image space. The icon is rendered to visually represent a data value at a data point in the image space, where the data value is retrieved from data within the storage module.

The received data value in this example=500. This value may represent, for example, $500 spent by a customer in a casino environment on one specific gaming device in one sitting.

The color used to represent the icon is based on the received data value. For example, in this embodiment, the colors in the range from red, orange, yellow, green to blue indicate the data values from a maximum to minimum value. Larger data values are represented using “hot” colors such as red and orange. Smaller data values are represented using “cold” colors such as blue and green. It will be understood that the present application is not limited to the type of mechanism used to determine the icon's color or shading and that any known mechanism for determining the color or shading of the icon may be used.

According to this example, the rendering system determines that the $500 data value is to be represented by the color RED.

The $500 data value is used by the size and transparency determination module to determine the size of the icon. That is, according to this embodiment, the size and transparency determination module ensures that the larger the data value, the larger the icon. Therefore, relatively small data values will generate smaller icons than relatively large data values.

According to this embodiment, the system renders icons having a size that is within a range between a maximum and minimum size value. The system may determine the maximum and minimum data values from the data retrieved. The system may then align the minimum data value with the minimum size value and align the maximum data value with the maximum size value. The size range may then be linearly distributed for the remaining data values between the minimum and maximum data values.

Alternatively, it will be understood that other methods for determining the size of an icon based on the data value may be utilized by the system. That is, any linear or non-linear relationship between the data values and icon size may be applied to determine the size of the icons. For example, an exponential relationship between the data values and icon size may be applied to determine the icon size. As a further example, the system may be arranged so that larger data values may produce smaller icons and vice versa. This may be particularly useful in systems for users that are more interested in visualizing the smaller data values than the larger data values.

According to this embodiment, the icon is generated or rendered as a circle. The system uses a direct relationship between the data value and the circle diameter to determine the icon's size. The center of the icon is located at the position of the data point within the image space. Alternatively, the icon's position may be offset from the data point.

As a further alternative, a relationship between the data value and the icon form may be used to determine how the icon is rendered. For example, a linear or non-linear relationship between the data values and icon form may be utilized in order to change one or more dimensions of the icon and so its overall form. For example, the width, length, radius, diameter, circumference or any other geometric variable associated with the icon may be adjusted based on the data value to vary the icon form.

The $500 data value is also used by the size and transparency determination module to determine the transparency of the icon.

According to this embodiment, transparency is based on what is known as an alpha value. The alpha value creates an additional term to be used alongside RGB values to provide a level of transparency to an image. It will be understood that, for various alternatives, other methods may be used to represent icons in a transparent manner other than applying alpha values.

In general, color pixels are normally rendered by applying RGB values to the pixels to determine the color. The color value is determined by the value of the tuple that represents the amount of red, blue and green being used to generate the pixel. For example, an RGB value of 1,0,0 will make the pixel completely RED, whereas an RGB value of 0,0,1 would produce a completely BLUE pixel. It can be seen that by applying different values for the different base colors that a pixel may be represented by any one of a whole range of different colors. For example, the RGB tuple 0,1,1 would produce a TURQUOISE colored pixel.

An alpha channel may be applied along with the RGB tuple values to determine the level of opacity or transparency of the selected base colors. For example, an alpha channel value of 1 would render the pixel completely opaque (or non-transparent) and an alpha channel value of 0 would render the pixel completely transparent (or non-opaque). Values between 0 and 1 may be used to vary the level of transparency (or opaqueness).

The alpha value may either pre-multiply the RGB values or not. According to this embodiment, a pre-multiplied alpha value is used. However it will be understood that as an alternative, the alpha value may be applied to the RGB tuples in a subsequent operation.

For example, taking the case of rendering a pixel with a fully RED color, the RGB & alpha values would be 1,0,0,1 where the first three digits represent the RGB values and the fourth digit represents the alpha channel. If it was required that the pixel should be slightly transparent, for example 50%, the RGB & alpha values used would be 0.5, 0, 0, 0.5. According to this example, the pre-multiplying has already occurred and so the R value of 1 is changed to 0.5 due to the 0.5 multiplying action of the alpha channel. These values are applied by the rendering engine when rendering the pixels within the icon associated with the current data point.

According to this embodiment, the size and transparency determination engine analyses the data to determine the maximum data value that is to be visualized. It assigns the alpha value 0 to the maximum data value, and assigns the alpha value 1 to the data value 0. A linear distribution of the alpha values between 1 and 0 is then applied to the data values. This can be particularly useful for data sets that do not have any negative values.

As an alternative, the size and transparency determination engine analyses the data to determine the minimum and maximum data values that are to be visualized. It assigns the alpha value 0 to the maximum data value, and assigns the alpha value 1 to the minimum data value. A linear distribution of the alpha values between 0 and 1 is then applied to the remaining data values. This method may be useful for data sets that include negative values, where the minimum data value is the most negative number.

As a further alternative, the alpha values used are between 0 and 1. The value 0 represents full transparency and the value 1 represents full opacity. The alpha value for use at a particular data point to render a particular icon is set by the size and transparency determination engine. The size and transparency determination engine receives the data from the data retrieval engine. It analyses the data to determine the maximum data value that is to be visualized. It assigns the alpha value 1 to the maximum data value, and assigns the alpha value 0 to the data value 0. The data values in between the 0 value and the maximum value are assigned an alpha value based on a linear distribution of the alpha values between 0 and 1. This arrangement is particularly useful where the data values do not include any negative values.

As yet a further alternative, the size and transparency determination engine may analyze the data to determine the minimum and maximum data values that are to be visualized. It assigns the alpha value 1 to the maximum data value, and assigns the alpha value 0 to the minimum data value. The data values in between the minimum value and the maximum value are assigned an alpha value based on a linear distribution of the alpha values between 0 and 1. This arrangement is particularly useful where the data values include negative values, where the minimum data value is the most negative number.

It will be understood that the distribution of the alpha values within the alpha value range between the minimum and maximum data values may also be non-linear. That is, for example, the distribution may be exponential or any other suitable non-linear distribution.

According to this embodiment, it can be seen that there is a direct relationship between the size and transparency values of the icons. It can also be seen that there is a direct relationship between each of the size & transparency values, and the data values. Further, the rendering of the icon only requires two dimensions and a single set of RGB & alpha values to graphically represent the entire area of the icon thus reducing complexity and providing a less computer intensive rendering process than prior known systems.

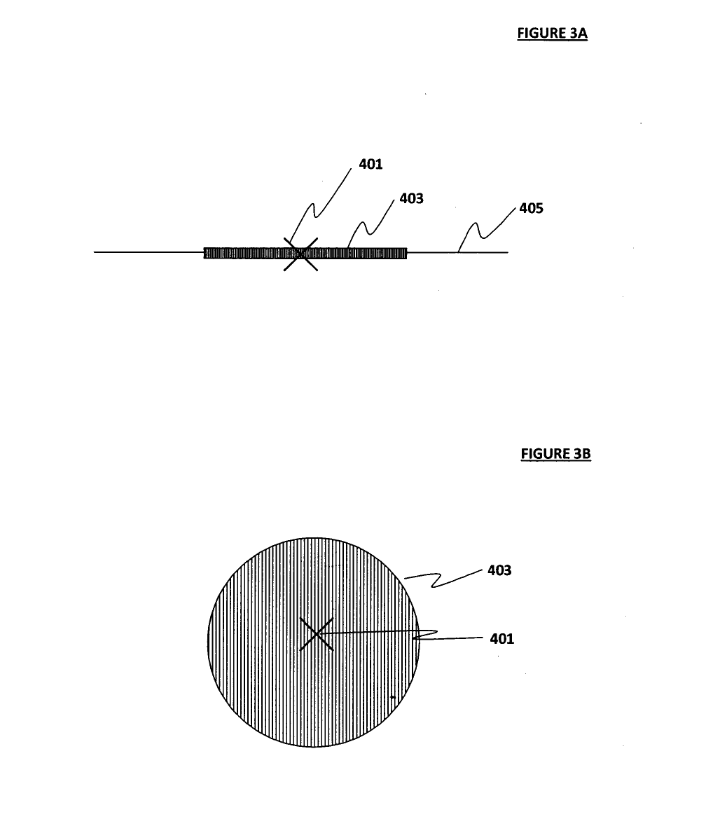

FIG. 3A shows a visual representation of a two dimensional icon being rendered. The view shown in FIG. 3A is taken looking in a direction parallel to and in line with the surface upon which the icon is being represented.

A data point 401 identifies the location the icon 403 is to be rendered in image space on an x-y co-ordinate system. For example, the data point may be at a position on a locational or geographical map that identifies a location where the data value being visually represented was recorded.

The image space 405 upon which the icon 403 is rendered is conceptually a two dimensional area as a “z” value is not required to graphically represent the icon. Only x and y values are required to identify the location and boundary of the icon, and the alpha value is used to determine the transparency of the color (or shade) in which the icon is to be rendered. It will be understood that the icon 403 as shown in FIG. 3A has been represented with minimal height merely to show its location within the figure and that conceptually the icon 403 has no height and is only defined by its x and y co-ordinate position, size, color (or shade) and transparency.

According to one example, the locational map may be a layout of a casino environment where the data point is associated with data values retrieved from a specific gaming device at a specific location. Alternatively, the locational map may be a factory or manufacturing environment where the data point is associated with data values retrieved from quality control measurement devices located in various locations within the environment. As a further alternative, the map may be a geographical map where the data point is associated with data values retrieved from a retail outlet within a specific town or city. Other alternatives are also considered where the locational or geographical map provides a layout of any defined building, location, floor plan, manufacturing or retail environment, testing environment, entertainment environment, office environment, travel environment (such as roads, waterways, flight routes etc), customer location plan and such like. Further, each map may have multiple layers used to represent different levels, such as floors or heights, within the map.

The image space itself may be used to display a layered representation that includes a locational or geographical map in a first layer, with the data points and icons in a further layer. Additional data and information may be placed on top of or below these layers using further layers. The rendering engine is arranged to render each of these layers in order to produce a complete visual representation.

It will be understood that the icons may be rendered using other forms of image space other than geographical or locational maps. For example, the image space may also be used to represent time periods, whether in parts of a second through to days, months and years. The image space may also be used to represent hierarchical relationships between elements, such as entity relationships, for example. Also, the image space may be used to represent a network and its interconnections and relationships, such as, for example, a computing network, social network, communications network, gene sequence interrelationships etc.

For example, the numbers being represented could indicate the variation between two gene sequences, or indicate the variation between one gene sequence and the standard gene.

It will be understood that the position of the data point within the visual representation may be identified by way of other methods besides x-y coordinates. For example, the data point position may be identified by GPS coordinates, latitude and longitude values, radial and distance values and such like.

FIG. 3B shows a plan view of the icon 403 of FIG. 3A as it is represented around the data point 401. That is, this view is looking down towards the image space. The size of the icon, i.e. its diameter in this embodiment, is defined by the data value associated with the data point 401. The transparency value is also defined by the data value associated with the data point 401.

### Second Embodiment

The same system as described with reference to FIG. 1 is also used to implement the following embodiment. The same principles of determining size and transparency values for the icons, and color or shade generation also apply as described above with reference to the first embodiment and its alternatives.

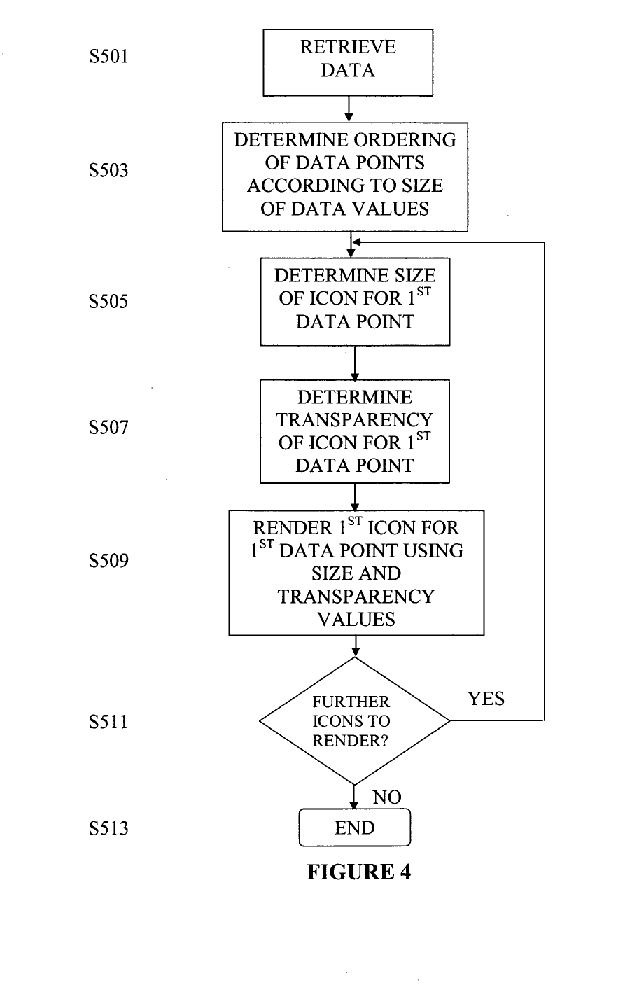

FIG. 4 shows a flow diagram of a method for generating multiple icons according to this embodiment.

Data (including data values) is retrieved from the data storage module by the data retrieval module at step S501. According to step S503, the ordering of the data points is determined based on the magnitude of the data values. At step S505, the size and transparency determination engine determines a size value for an icon associated with the first data point in the order. At step S507, the size and transparency determination engine determines a transparency value for an icon associated with the first data point. At step S509, the rendering engine renders the first icon for the first data point using the determined size and transparency values. At step S511, the system determines if there are any further icons to be rendered, and if so, returns to step S505. If no further icons are to be rendered, the process stops at step S513.

According to this embodiment, an alpha value of 0 is used when representing a maximum data value, and an alpha value of 1 is used when representing a zero data value.

Further, in terms of representing the size of the icon, the larger the data value the larger the icon, and the smaller the data value the smaller the icon.

The ordering of the data points, and so the order in which the associated icons are rendered, is based on the size of the data values associated with the data points. According to this embodiment, the ordering is from the smallest data value to the largest data value such that the smallest data values are processed first thus generating the icons in order from smallest up to the largest. It will be understood therefore, that in this embodiment, the least transparent (most opaque) icons are rendered first and the most transparent icons (least opaque) are rendered afterwards.

It will be understood that, as an alternative, the rendering order may be reversed such that the largest icons with the largest data values are rendered first.

According to this embodiment and the above alternative, there is no requirement for additional processing to ensure the larger icons do not hide the smaller icons, as the larger icons being rendered are more transparent than the smaller icons and so when being rendered allow the smaller icons to be visually distinguishable from the larger icons.

According to this embodiment, the larger the data value for the data point, the greater the transparency value, and the lower the alpha value, so that larger icons are more transparent than smaller icons. Therefore, a minimum alpha value is assigned to a maximum determined data value.

It will be understood that, as an alternative, the rendering may be achieved based on the smaller the data value for the data point, the greater the transparency value and the higher the alpha value, so that smaller icons are more transparent than larger icons. Therefore, a maximum alpha value is assigned to a maximum determined data value. In this case, the larger icons are rendered before the smaller icons, i.e. in order from largest to smallest.

According to further alternatives, a minimum data value may be determined from the retrieved data and a minimum or maximum alpha value may be assigned to the determined minimum data value. The ordering of rendering the associated icons may be either from least transparent to most transparent or vice versa. In order to avoid hiding smaller transparent icons by rendering over them with larger opaque icons in the case where smaller icons are rendered before larger ones, additional processing may be applied by the rendering engine.

The additional processing may ensure that the larger icons do not hide the smaller icons by identifying the area bounded by the smaller icons and instructing the rendering engine not to overwrite that identified area. Alternatively, the additional processing may cause the rendering engine to re-render the smaller icon after the larger icon has been rendered to effectively overwrite the larger icon.

It will be understood that if the rendering order is from the most transparent to the opaque icons, and the larger icons are more opaque than the smaller icons, the additional processing may be required in order to more easily visually distinguish between the smaller and larger icons.

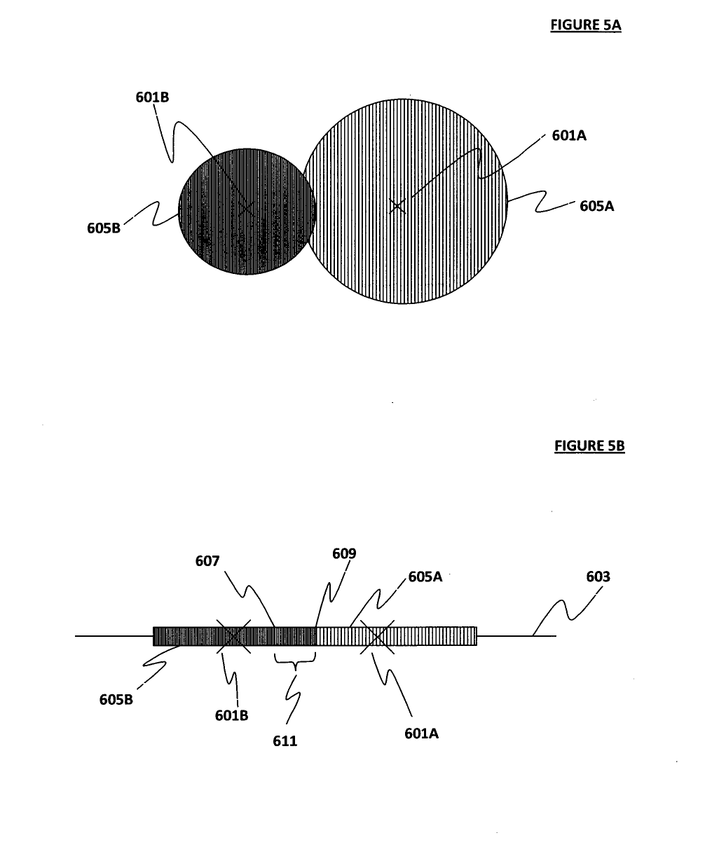

FIGS. 5A and 5B shows an example of two overlapping icons generated according to the method described with reference to FIG. 4. In this example, the icons only partially overlap.

A first icon 605A representing a data value for data point 601A is rendered first. A second icon 605B representing a data value for data point 601B is rendered after the first icon. The first icon 605A has a greater transparency value (lower alpha value) than the second icon 605B. Therefore, the second icon appears to overlap the first icon in an overlap area 611 (see FIG. 5B) ensuring that the larger first icon does not hide the properties of the smaller second icon.

Therefore, in this embodiment, the overlapping area is rendered based on the rendering features of the smallest icon, i.e. the icon that has the lowest transparency value (highest alpha value).

It will be understood however, that, as an alternative, the overlapping area may be rendered based on the rendering features of the largest icon, which has the highest transparency value (lowest alpha value). Additional processing as described above may be applied to visually distinguish the overlapping area, such that a small icon completely overlapped by a larger icon may become more visible.

FIG. 5B shows a conceptual cross sectional view of the overlapping icons 601A & 601B rendered on a surface 603, where the boundary 607 of icon 601A can be seen as well as the boundary 609 of icon 601B. The overlapping area 611 is located in between these boundaries.

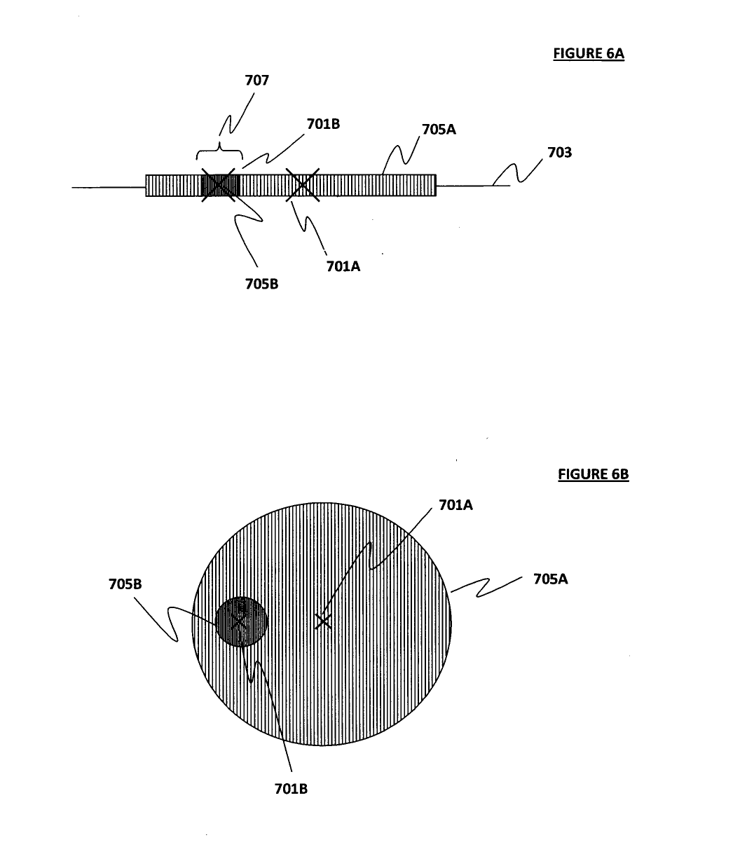

FIGS. 6A and 6B show two further overlapping icons generated according to the method described with reference to FIG. 4. In this example, a second icon is located completely within the boundary of a first icon.

The first icon 705A is rendered first around a data point 701A on a surface 703. The second icon 705B is rendered after the first icon around a data point 701B. The first icon has a larger transparency value (lower alpha value) than the second icon due to the first icon being larger. As described above, it will be understood that the first icon may be rendered after the second icon.

Further, it will be understood that the first icon may have a lower transparency value than the second icon and that additional processing may be applied to visually distinguish the two icons.

The second icon 705B is completely within the bounds of the first icon 705A, however as it has been rendered using a lower transparency value it is clearly visible.

It will be understood that the icons may be rendered using compositing algebra. That is, the compositing algebra may apply any one or more of the compositing algebra operations as will be understood by the skilled person. For example, the operations that may be applied include over, in, held out by, atop, Xor and the reverse equivalents thereof.

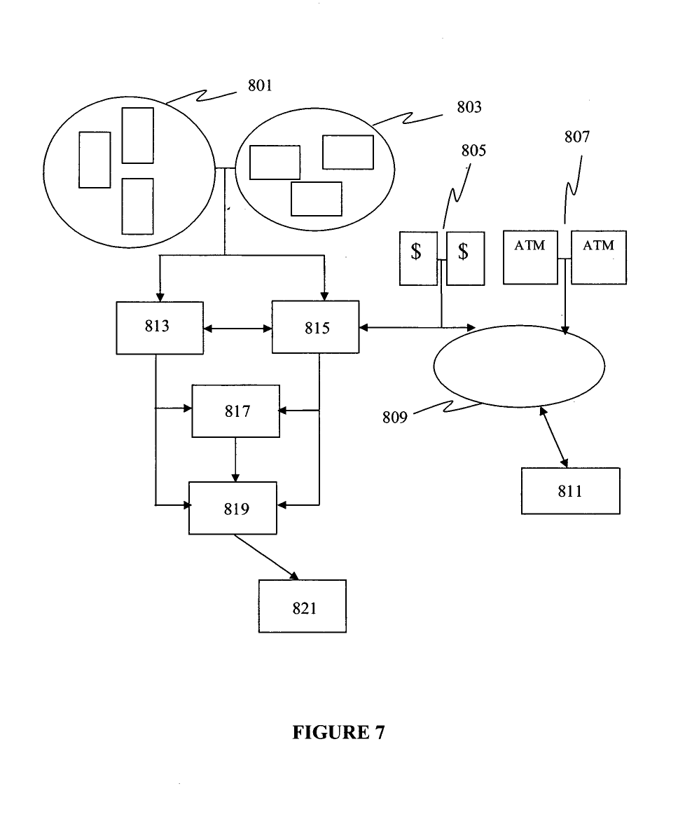

FIG. 7 shows an example of how the herein described system may be incorporated within a gaming environment. Any of the herein described methods may be applied by the described system. The gaming environment consists of a number of gaming machines 801 and electronic tables 803 (among other electronic gaming devices) that are adapted to communicate electronically with other systems using any suitable protocols, such as data packet protocols.

The gaming environment further includes a number of electronic cashier devices 805 and ATMs 807 which are in communication via a Wide Area Network 809 with one or more financial databases 811.

Data from the gaming machines 801 and electronic tables 803 are transferred to a reward program database 813 and customer database 815. It will be understood that these two databases may be combined into a single database.

Data from the cashier devices are also transferred to the reward program database 813 and customer database 815. The databases 813 and 815 are in communication with a central hotel management system 817 that oversees the operation of the gaming environment, including the activities of customers in other areas of a casino, such as shops, hotels, spas etc.

The system 819 described herein is in communication with the reward program database 813, customer database 815 and central hotel management system 817 so the system can retrieve all necessary data about the activities within the gaming environment. The various embodiments as described herein are employed by the system 819 to provide an output 821.

The embodiments herein described provides an efficient computer processing method for visualizing data values without requiring a step of surface rendering. This eliminates memory requirements for surface rendering as no surface is rendered.

### Further Embodiments

It will be understood that the embodiments of the present invention described herein are by way of example only, and that various changes and modifications may be made without departing from the scope of invention.

For example, it will be understood that the icon may be any suitable shape. For example, the icon may be a polygon, circle or ellipse.

Further, it will be understood that the representation of data values may be rendered in any format suitable for displaying on a display device. For example, the output generated by the rendering engine may be modified or adapted to fit any suitable display screen.

Further, it will be understood that the representation of data values may be rendered in any format suitable for printing on a printer. For example, the output generated by the rendering engine may be modified or adapted to be applied by any suitable printer driver for printing on any suitable printing device.

Further, it will be understood that when assigning the alpha values to the maximum and/or minimum values that an offset value may be applied to the actual alpha value used to ensure that the alpha value used is never set as zero. This ensures that the relevant data values are always at least semi-transparent and so visible in the graphical visualization.

1. In a data visualization system, a method of generating a representation of data values for a plurality of data points being visualized in an image space, the method comprising the steps of the data visualization system:
i) retrieving data values from a data storage module in communication with the data visualization system, wherein a first data value is associated with a first data point,
ii) determining a size and a transparency value for a first icon based on the first data value, and
iii) rendering the first icon in two dimensions in a position associated with the first data point in the image space, wherein the first icon is rendered based on the determined size and transparency values to generate a representation of the data value.

2. The method of claim 1, further comprising the step of rendering the first icon based on a direct relationship between the size and transparency values of the first icon and a magnitude value of the first data value.

3. The method of claim 1, further comprising the step of determining the transparency value by calculating an alpha value based on the first data value.

4. The method of claim 3, further comprising the steps of calculating the alpha value from a range of alpha values by determining a maximum data value from the data values retrieved from the data storage module and setting the range of alpha values based on the maximum data value.

5. The method of claim 4, further comprising the step of setting a minimum alpha value in the range of alpha values based on the maximum data value.

6. The method of claim 4, further comprising the step of setting a maximum alpha value in the range of alpha values based on the maximum data value.

7. The method of claim 3, further comprising the steps of calculating the alpha value from a range of alpha values by determining a minimum data value from the data values retrieved from the data storage module and setting the range of alpha values based on the minimum data value.

8. The method of claim 7, further comprising the step of setting a minimum alpha value in the range of alpha values based on the minimum data value.

9. The method of claim 7, further comprising the step of setting a maximum alpha value in the range of alpha values based on the minimum data value.

10. The method of claim 1, further comprising the step of generating the representation of data values by applying RGB values and an alpha value to pixels around the first data point to render the first icon.

11. The method of claim 10, further comprising the step of associating the first icon with an alpha value that is between a minimum and maximum value, where the minimum alpha value indicates full transparency and the maximum alpha value indicates full opaqueness of the pixels being rendered within the bounds of the first icon.

12. The method of claim 1, further comprising the steps of
iv) rendering a second icon in two dimensions based on a second data value, wherein the second icon is rendered in a position associated with a second data point such that the second and first icons overlap,
wherein the rendering step comprises the steps of:
v) determining a size and a transparency value for the second icon based on the second data value, and
vi) rendering the second icon based on the determined size and transparency values for the second icon to generate a representation of the second data value, wherein the overlapping area is rendered using the determined transparency values of one of the first and second icons.

13. The method of claim 12, further comprising the step of rendering the first and second icons using compositing algebra.

14. The method of claim 13, wherein the compositing algebra applies one or more of the operations: over, in, held out by, atop, Xor and the reverse equivalents thereof.

15. The method of claim 12, further comprising the step of rendering the overlapping area based on the transparency value of the smaller of the two icons.

16. The method of claim 15, wherein the transparency value is based on a minimum or maximum alpha value associated with the first or second data values.

17. The method of claim 12, further comprising the step of rendering the icons in order from the icon with the lowest transparency value through to the icon with the highest transparency value.

18. The method of claim 12, further comprising the step of rendering the icons in order from the icon with the highest transparency value through to the icon with the lowest transparency value.

19. The method of claim 1, wherein the higher the data value, the higher the transparency value allocated to the icon.

20. The method of claim 1, wherein the higher the data value, the lower the transparency value allocated to the icon.

21. The method of claim 1, wherein the larger the data value the larger the size of the icon.

22. The method of claim 1, wherein the larger the data value the smaller the size of the icon.

23. The method of claim 1, wherein the icon is one of a polygon, circle or ellipse.

24. The method of claim 1 further comprising the steps of repeating steps i) to iii) to render further icons in two dimensions based on further data values.

25. The method of claim 1, further comprising the step of rendering the representation of data values in a format suitable for displaying on a display device.

26. The method of claim 1, further comprising the step of rendering the representation of data values in a format suitable for printing using a printer.

27. A data visualization system for generating a representation of data values for a plurality of data points being visualized in an image space, the data visualization system comprising:
a data retrieval engine arranged to retrieve data values from a data storage module in communication with the data visualization system, wherein a first data value is associated with a first data point,
a size and transparency determination engine arranged to determine a size and a transparency value for a first icon based on the first data value, and
a rendering engine arranged to render the first icon in two dimensions in a position associated with the first data point in the image space, wherein the first icon is rendered based on the determined size and transparency values to generate a representation of the data value.

28. The system of claim 27, wherein the rendering engine is further arranged to render the first icon based on a direct relationship between the size and transparency values of the first icon and a magnitude value of the first data value.

29. The system of claim 27, wherein the size and transparency determination engine is further arranged to determine the transparency value by calculating an alpha value based on the first data value.

30. The system of claim 29, wherein the size and transparency determination engine is further arranged to calculate the alpha value from a range of alpha values by determining a maximum data value from the data values retrieved from the data storage module and setting the range of alpha values based on the maximum data value.

31. The system of claim 30, wherein a minimum alpha value in the range of alpha values is set based on the maximum data value.

32. The system of claim 30, wherein a maximum alpha value in the range of alpha values is set based on the maximum data value.

33. The system of claim 29, wherein the size and transparency determination engine is further arranged to calculate the alpha value from a range of alpha values by determining a minimum data value from the data values retrieved from the data storage module and setting the range of alpha values based on the minimum data value.

34. The system of claim 33, wherein a minimum alpha value in the range of alpha values is set based on the minimum data value.

35. The system of claim 33, wherein a maximum alpha value in the range of alpha values is set based on the minimum data value.

36. The system of claim 27, wherein the rendering engine is further arranged to generate the representation of data values by applying RGB values and an alpha value to each pixel around the first data point to render the first icon.

37. The system of claim 36, wherein the first icon is associated with an alpha value that is between a minimum and maximum value, where the minimum alpha value indicates full transparency and the maximum alpha value indicates full opaqueness of the pixels being rendered within the bounds of the first icon.

38. The system of claim 27, wherein the rendering engine is further arranged to render a second icon in two dimensions based on a second data value, wherein the second icon is rendered in a position associated with a second data point such that the second and first icons overlap,
the rendering engine yet further arranged to determine a size and a transparency value for the second icon based on the second data value, and
render the second icon based on the determined size and transparency values to generate a representation of the second data value, wherein the overlapping area is rendered using the determined transparency of one of the first and second icons.

39. The system of claim 38, wherein the rendering engine is further arranged to render the first and second icons using compositing algebra.

40. The system of claim 39, wherein the compositing algebra applies one or more of the operations: over, in, held out by, atop, Xor and the reverse equivalents thereof.

41. The system of claim 38, wherein the rendering engine is further arranged to render the overlapping area based on the transparency value of the smaller of the two icons.

42. The system of claim 41, wherein the transparency value is based on a minimum or maximum alpha value associated with the first or second data values.

43. The system of claim 38, wherein the rendering engine is further arranged to render the icons in order from the icon with the lowest transparency value through to the icon with the highest transparency value.

44. The system of claim 38, wherein the rendering engine is further arranged to render the icons in order from the icon with the highest transparency value through to the icon with the lowest transparency value.

45. The system of claim 27 wherein the higher the data value, the higher the transparency value allocated to the icon.

46. The system of claim 27, wherein the higher the data value, the lower the transparency value allocated to the icon.

47. The system of claim 27, wherein the larger the data value the larger the size of the icon.

48. The system of claim 27, wherein the larger the data value the smaller the size of the icon.

49. The system of claim 27, wherein the rendering engine is further arranged to render the icon as a polygon, circle or ellipse.

50. The system of claim 27 wherein the rendering engine is further arranged to render further icons in two dimensions based on further data values.

51. The system of claim 27 wherein the rendering engine is further arranged to render the representation of data values in a format suitable for displaying on a display device.

52. The system of claim 27 wherein the rendering engine is further arranged to render the representation of data values in a format suitable for printing using a printer.
